(19) United States
(12) Patent Application Publication
(10) Pub. No.: US 2008/0263791 A1
(43) Pub. Date: Oct. 30, 2008

(54) HEAVY DUTY LOADING RAMP FOR CARGO TRANSPORTING APPARATUS

(76) Inventor: Thomas Edward Roberts, Bristol, IN (US)

Correspondence Address: SACHNOFF & WEAVER, LTD., 10 SOUTH WACKER DRIVE, CHICAGO, IL, 60606-7507, US

(21) Appl. No.: 11/924,301

(22) Filed: Oct. 25, 2007

Related U.S. Application Data
(60) Provisional application No. 60/863,099, filed on Oct. 26, 2006.

(51) Int. Cl. B65G 69/28

(52) U.S. Cl. 14/71.1

(57) ABSTRACT

An expandable and retractable ramp assembly for conveying moving objects onto a cargo carrying surface of a cargo transporting apparatus comprising:
a. a pair of opposed, parallel scissors assemblies, with each scissors assembly including a plurality of scissors link members pivotally attached to other scissors link members of the same scissors assembly. A plurality of tread support assemblies, extend between and are pivotally attached to one of the scissors link members of each opposed scissors assembly. Each tread support assembly is constructed of a plurality of support members pivotally attached to the scissors link members of each opposed scissors assembly. Each tread support assembly supports at least one tread plate.
   In an embodiment, each slidable mounting bracket includes a compressible cushion member that prevents the ramp from reaching a flat or over-center position when in the expanded position. In a further embodiment, certain of the scissors link members are no longer than others, providing an upwardly extending arcuate bend in the mid-portion of the ramp assembly to prevent vehicles with low-frame constructions from contacting the junction between the ramp and a truck tailgate, or other structure to which the ramp is attached, when the vehicle is moving up or down the ramp.

### RELATED APPLICATIONS

This non-provisional application claims priority to provisional patent application Ser. No. 60/863,099 filed Oct. 26, 2006, to the extent allowed by law.

### FIELD OF THE INVENTION

The present invention relates to expandable and retractable loading ramps for cargo transporting apparatus, such as pick-up trucks, larger trucks, flat bed trucks, cargo trucks, railroad cars, boats and the like. Specifically, the present invention provides an improvement over existing loading ramps by providing an expandable and foldable ramp structure that is light enough in weight to be manually installed and removed from a truck or other transport vehicle, yet constructed with sufficient strength to support heavier vehicles, such as off road vehicles for example, that are being produced and sold today.

### BACKGROUND OF THE INVENTION

Over the past few years, sales of recreational vehicles have increased as citizens have more time and options as to how they spend their leisure hours. Such recreational vehicles include on-road vehicles such as cycles and RV's, and off road vehicles such as all terrain vehicles (ATV's), snowmobiles, and other such vehicles that cannot be operated on public highways and roads. It is necessary to transport off road vehicles from one place to another for use, usually employing a small or medium size pick-up truck or the like. In addition, lawn and garden vehicles, such as riding mowers, small tractors and the like, may also require transportation from one place to another by small or medium size trucks. In addition, such off road vehicles are being constructed larger and heavier compared to earlier vehicles to accommodate consumer demands. Some such vehicles weigh in the neighborhood of 1,300 pounds.

Since the beds of small and medium sized trucks and similar vehicles are situated several feet off the ground, it is necessary to elevate an off road vehicle to enable it to be loaded onto a truck. In the past, several loading ramp type devices of the non-fully expandable and retractable type have been developed in an effort to provide such loading capability. Such prior loading ramps are disclosed by way of example, in U.S. Pat. No. 3,352,440; No. 3,713,553; No. 3,870,170, and No. 4,290,728. None of the ramps disclosed in these patents are fully expandable and retractable, nor are any of the disclosed ramps capable of being substantially folded into a small footprint when not in use. In addition, these prior ramps are not constructed with sufficient strength to support the heavier off road and other vehicles produced today that a user may desire to transport from place to place on the bed of a truck or other cargo vehicle.

An expandable and retractable lazy-tong type ramp structure is shown in Archer U.S. Pat. No. 4,527,941. This device incorporates a pair of lazy-tong or foldable scissors mechanisms for creating a storable ramp, wherein the floor of the structure is formed by wooden planks extending between parallel extending scissors linkages, or planks of steel reinforced with ribs or flanges. In either situation, wooden or steel planks would result in a ramp structure that would be too heavy for manual manipulation upon expanding and retracting the ramp, or even removing the ramp structure from the truck or other vehicle when not in use.

In addition, the horizontal planks in the Archer device rely on the strength of each individual plank to be able to support heavy loads on the ramp. If one of the wooden planks has a flaw, that plank may fail under heavy load, increasing the distributive weight carried by the remaining planks. This added weight may cause failures in other planks. There is no teaching or suggestion in the Archer reference how the planks, made either of heavy wood or steel, would be reinforced while keeping the total weight of the ramp structure at a minimum to allow manual manipulation of the ramp.

Additionally, the Archer disclosure does not teach an expandable and retractable ramp that can be readily and manually mounted to and removed from the bed or tailgate of a truck when the ramp is not in use and additional cargo space in the truck bed is desired. Further, the Archer device does not disclose a compression apparatus to prevent the scissors mountings and ramp tread plates from locking out, or going over center or to a flat configuration, when the ramp is expanded.

In view of the above, an object of the present invention is to provide a lightweight, manually manipulative expandable and retractable ramp for loading and unloading vehicles and other mobile equipment onto or from a raised bed of a truck or other cargo carrier.

Another object of the present invention is to construct the afore-described ramp with sufficient internal structural strength to allow heavy off road and other vehicles to be supported by the ramp, while at the same time not adding to the weight of the ramp.

Another object of the present invention is to provide an expandable and retractable ramp for loading and unloading mobile objects onto and from a truck bed or other cargo carrier, wherein the platform treads functioning as the horizontal load bearing elements of the ramp comprise a plurality of lightweight, horizontal, tubular configured beams having tread plates extending and absorbing stresses between certain of the beams, while the tread plates include counter sunk apertures to decrease the weight of the ramp and simultaneously add strength to the normally flat tread plates.

Further, an object of the present invention is to provide an expandable and retractable ramp for mounting on the lift gate of a truck, wherein the ramp, in its retracted position, is movable to a first position relative to the lift gate to allow storage of the retracted ramp on the bed of the truck with the lift gate closed, and wherein the ramp is movable to a second position relative to the liftgate when the ramp is expanded to provide maximum expansion of the ramp when the tail gate is opened.

Yet another object of the present invention is to provide an expandable and retractable ramp for loading and unloading objects onto and off of a cargo vehicle, wherein the ramp employs a lazy-tong or scissors mechanism with a unique compression bumper assembly that prevents the scissors mechanism and the tread plates of the present invention from locking out over 180 degrees when the ramp is in an over-center or horizontal position.

A further object of an embodiment of the present invention is to provide an expandable and retractable ramp that permits vehicles having a low-hanging frame portion between the forward and rear wheels to advance from the ramp onto the truck bed or other transport bed without the low-hanging frame coming into contact with the truck bed, or with the junction between the ramp and the truck bed, or tailgate. This embodiment comprises a novel ramp structure having a centrally disposed upwardly arcuate portion when the ramp is fully extended, wherein the rear wheels of a wheeled vehicle, or the rear tread portion of a treaded vehicle, are elevated as the front wheels or front tread portion advances from the ramp and onto the truck bed or other cargo carrier.

### SUMMARY OF THE INVENTION

An expandable and retractable ramp assembly is provided for conveying moving objects onto a cargo carrying surface of a cargo transporting apparatus, the assembly having rail-like mounting elements adapted to be securely attached to a portion of the cargo transporting apparatus. The expandable and retractable ramp assembly is removably and pivotally mounted to the rail-like mounting elements for linear and rotative movement of the ramp assembly relative to the rail-like mounting elements. The ramp assembly also comprises a pair of parallel and oppositely disposed scissors assemblies, and a tread support assembly extending between and operatively connected to links pivotally attached to the pair of parallel scissors assemblies. The tread support assembly includes a plurality of tread plates each connected to a plurality of support members. The support members are securely fastened to links attached to the scissors assemblies, and the tread plates and support members are adapted to support and distribute, in combination, heavy loads on the ramp assembly. Each of the tread plates includes a plurality of apertures extending through the tread plates. Raised edges are circularly disposed about each aperture, the raised edges providing a combination of added strength and a gripping surface to the tread plates.

In an embodiment of the invention, an arc is formed in the central portion of the ramp to elevate that portion of the ramp. The arc is formed by inserting elongated scissors links at certain locations along the extent of the opposed scissors assemblies of the ramp structure. In this embodiment, the arc is formed over the central portion of the ramp only, so as not to increase the angle at which a vehicle will enter the ramp, or leave the ramp.

### BRIEF DESCRIPTION OF THE DRAWINGS

The above and other objects and advantages of the present invention as hereinafter described will become apparent from reference to the detailed description of the illustrated embodiment as set forth below, and the accompanying drawings, wherein:

FIG. 1 is a perspective view of an embodiment of the expandable and retractable ramp of the present invention, shown in its retracted or storage position and movably mounted on the tailgate of a cargo vehicle such as a small truck, shown in the ramp's position just after the tailgate is rotated to an open position;

FIG. 2 is a perspective illustration of the ramp of FIG. 1, shown in its retracted position when the tailgate is opened, the ramp rotated ninety degrees from the position shown in FIG. 1, and prior to initiating expansion of the ramp;

FIG. 3 is a side perspective view of the ramp of FIG. 1 moved to a forward position on the open tailgate, with the ramp shown in its initial stages of expansion;

FIG. 4 is a side perspective view of the ramp of FIG. 1 shown in a further expanded position relative to the expanded position shown in FIG. 3;

FIG. 5 is a side perspective view of the ramp of FIG. 1 shown in its fully expanded position;

FIG. 6 is a side perspective view of the ramp of FIG. 1 shown in its fully expanded position, with one end in contact with the surface from which a load is to be advanced along the ramp and onto the truck;

FIG. 7 is a side perspective view of the ramp of FIG. 1, shown in a partially expanded position and forming steps leading to and from the truck;

FIG. 8 is a detail perspective view of the tread support assembly of the present invention;

FIG. 9 is a detail perspective view of the sliding mounting bracket and removable ramp attachment assembly of the present invention;

FIG. 10 is another detail perspective view showing the pivotal structure for mounting one end of the ramp of FIG. 1 to the sliding support structure mounted on the tailgate of a cargo vehicle;

FIG. 11 is a detail illustration showing the locking assembly for securing the retracted ramp in a non-moveable position on the tailgate when the ramp is not in use;

FIG. 12 is a detail view of the scissors mechanism of the present invention, also showing the tread plate support assembly mounted to links that are pivotally attached to the scissors mechanism and to a sliding mounting bracket;

FIG. 12A is a detail perspective view showing how the tubular tread supports are fastened to the linkage members of the present invention;

FIG. 13 is a detail perspective view of the removable mounting assembly for pivotally mounting the ramp structure to the sliding support structure on the tailgate;

FIG. 14 is a detail view of the compression bumper assembly of the present invention, shown in a de-compressed position;

FIG. 15 is a detail view of the compression bumper assembly of FIG. 14, shown in a compressed position;

FIG. 16 is a detail view of the compression bumper assembly of FIG. 14, shown in its raised or inactive position;

FIG. 17 is a side perspective view of an embodiment of the invention providing an arcuate surface in the central portion of the ramp; and

FIG. 18 is a detail view of the scissors mechanism of the embodiment of the present invention shown in FIG. 17, illustrating several scissors links having a greater length than other scissors links.

### DETAILED DESCRIPTION OF THE ILLUSTRATED EMBODIMENT

The present invention provides an expandable and retractable ramp assembly for loading heavy objects, such as off road vehicles, snowmobiles, tractors, garden and farm implements, cargo of varying types, employing tire or tread traction systems, and the like, onto cargo vehicles and transport devices such as trucks of all sizes, railroad cars, boats, etc. The ramp assembly embodiments of the present invention are designed to support loads in the range of 1200 to 1300 pounds, or more, and to be retractable for storage in the cargo vehicle when not in use. In addition, the retracted ramp can be readily detached altogether from the truck, railroad car or boat with which it is used, to allow additional cargo space in the truck, car or boat, and permit storage of the retracted ramp in a more convenient location.

The present invention utilizes a uniquely reinforced scissors, or lazy tong, expandable and retractable mechanism, link structure and reinforced tread support assembly of the disclosed ramp. The tread support assembly is constructed to support and spread the load of today's heavier off-road and other vehicles and implements that require transport from one place to another.

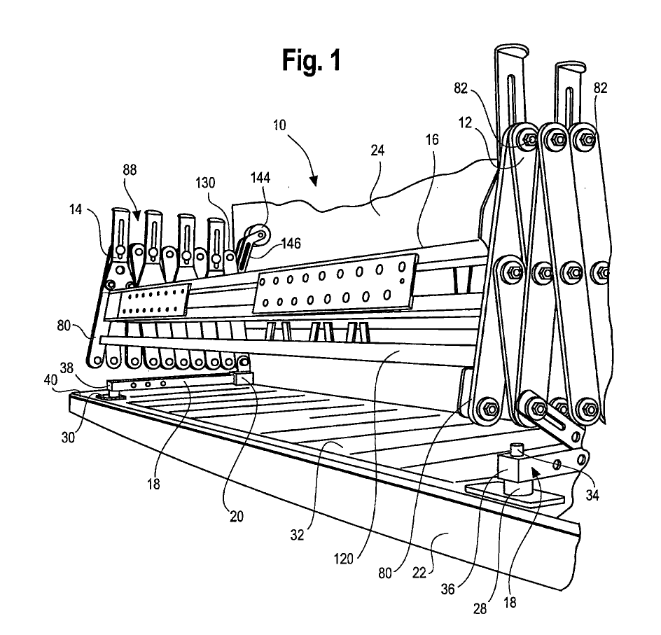

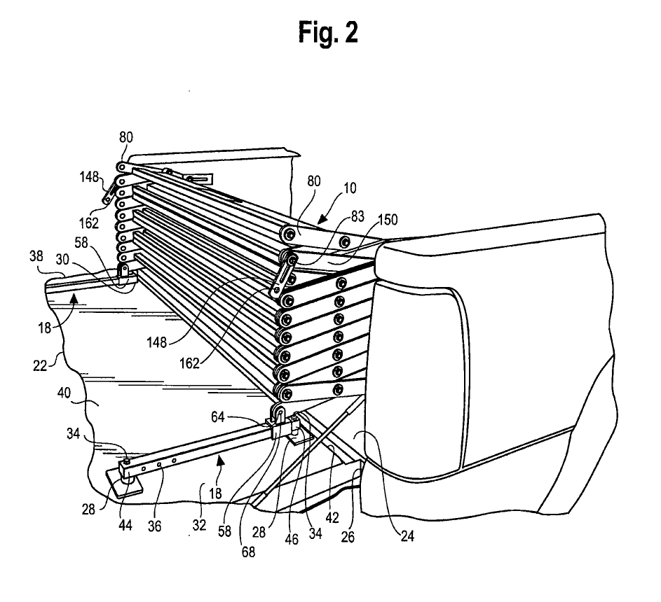

Referring to FIGS. 1 through 8, an embodiment of the ramp assembly is generally designated by the numeral 10. The ramp assembly 10 generally comprises opposing expandable and retractable parallel scissors assemblies 12 and 14, with a tread support assembly 16 extending between and attached to certain links of the scissors assemblies 12, 14 as will be described. The ramp 10 also includes a unique mounting assembly 18 that is used to moveably and detachably attach the ramp assembly 10 to a sliding mounting bracket 20, the latter being attached to the tailgate 22 of a truck bed 24 in the illustrated embodiment. It is understood that the ramp assembly 10 could likewise be installed in a railroad car, boat, or other cargo-handling or passenger transport device. The tailgate 22, as shown in FIGS. 1 and 2 is adapted to open and close about pivot joints 26 connecting the tailgate 22 to the rear of the truck bed 24.

Referring to FIGS. 1, 2 and 9, a pair of rail mounting assemblies 28 and 30 are securely fixed to the inside panel 32 of tailgate 22. In the illustrated embodiment, each rail assembly 28, 30 includes a rectangular tubular rail 36, 38 extending substantially the full width of tailgate panel 32, within about one inch from either edge 40, 42 of tailgate panel 32 in the illustrated embodiment. These dimensions may change in accordance with the width of the tailgate 22.

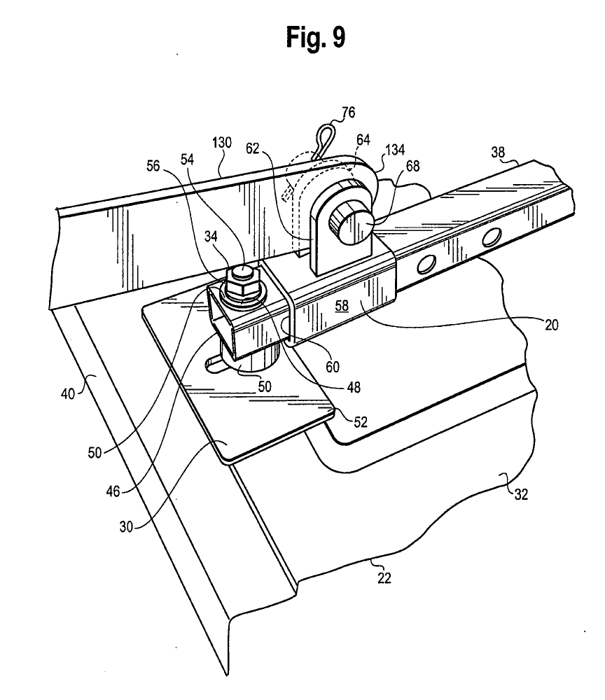

Each end 44, 46 of the rails 36, 38 is secured and removably fastened to tailgate panel 32 by extending a bolt 34 (FIG. 9) through opposing apertures 48 in the rails 36, 38. The bolt 34 then extends through a bushing 50, an aperture (not shown) in mounting plate 52, and through an aligned aperture (not shown) in panel 32. In the illustrated embodiment, bolt 34 comprises an upper straight threaded shank 54, and a lower portion (not shown) at the end of the shank 54 opposite the threads. The lower portion of bolt 34 is bent to extend at a right angle to shank 54, wherein the bolt 34 is substantially “L” shaped. The lower right angle portion of bolt 34 extends beneath the upper surface of panel 32, and along a portion of the lower surface of panel 32, as the panel 32 is seen in FIGS. 2 and 9. Thus, when nut 56 is tightened on threaded shank 54, the lower right angle portion of bolt 34 bears against panel 32, forcing the area of panel 32 around the lower right angle portion to bear against respective mounting plate 52, thus securing each tubular rail 36, 38 against tailgate panel 32. The same type of mounting assembly is utilized at each end 44, 46 of both rails 36, 38 in the illustrated embodiment. It is understood that other suitable mounting assemblies as are known in the art may be used to securely and removably attach rails 36, 38 to the inside panel 32 of tailgate 22.

Referring to FIGS. 2, 9, 10 and 13, the mounting assembly 18 on each side of panel 32 includes a tubular slide 58 having an interior hollow configuration 60 the same shape as, but slightly larger than, the outer configuration of corresponding rail 36, 38. Thus, the tubular slide 58 is adapted to move along the entire length of its corresponding rail 36, 38.

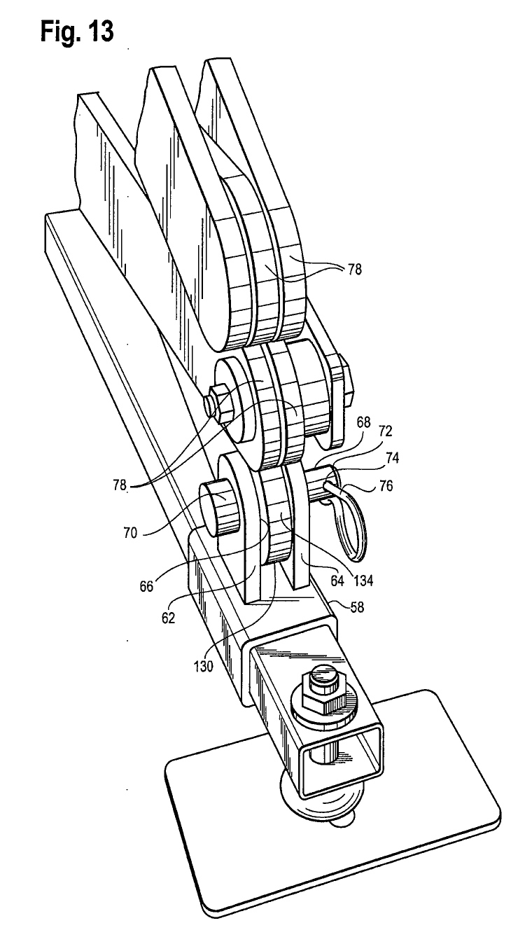

A pair of spaced-apart parallel vertically extending flanges 62, 64 are mounted on an upper surface of each slide 58. Each flange 62, 64 has an aperture (not shown) aligned with an aperture in the adjacent flange 62, 64. A mounting pin 68 removably extends through the apertures in flanges 62, 64. Referring to FIG. 13, pin 68 includes a head end 70 and a shank end 72. The shank end includes a radially extending aperture 74 that receives a removable locking pin 76. The locking pin 76 prevents removal of mounting pin 68 from apertures in flanges 62, 64 when pin 76 is inserted in aperture 74. Likewise, the removal of locking pin 76 from aperture 74 allows removal of mounting pin 68 from the apertures in flanges 62, 64. This feature of mounting assembly 18 allows the selected removal and replacement of ramp assembly 10 on the inside panel 32 of tailgate 22, as will be explained.

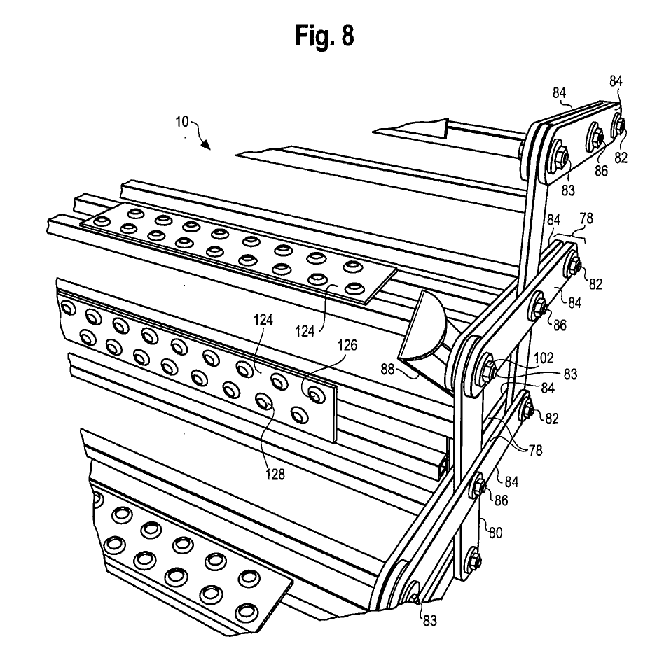

Referring to FIGS. 1-5, 8 and 12, ramp assembly 10 comprises two parallel scissors assemblies 12, 14 that are mirror images of each other. The description of one scissors mechanism herein is intended to apply equally to the opposite scissors mechanism. Each scissor mechanism 12, 14 comprises a plurality of parallel double linkage assemblies 78 (FIG. 8) that are pivotally connected to single linkage members 80 at or adjacent the opposite ends of each double link assembly and each adjacent single linkage member 80 by means of bolts 82 at one end and bolt 83 at the opposite ends of the link assembly. Single linkage members 80 extend between the individual links 84 forming double linkage assembly 78, and the individual links 80 are pivotally connected at their center point to each link 84 by a bolt 86. The above described linkage assembly is known the art as a “lazy-tong” device, and is used to provide expandable and retractable mechanisms for various uses.

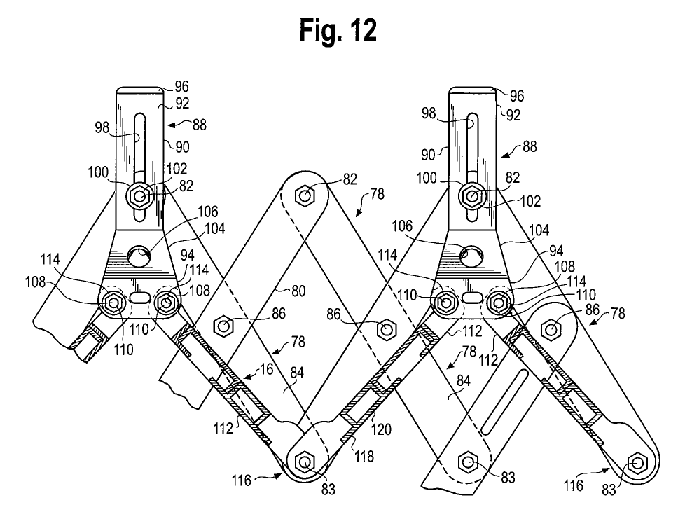

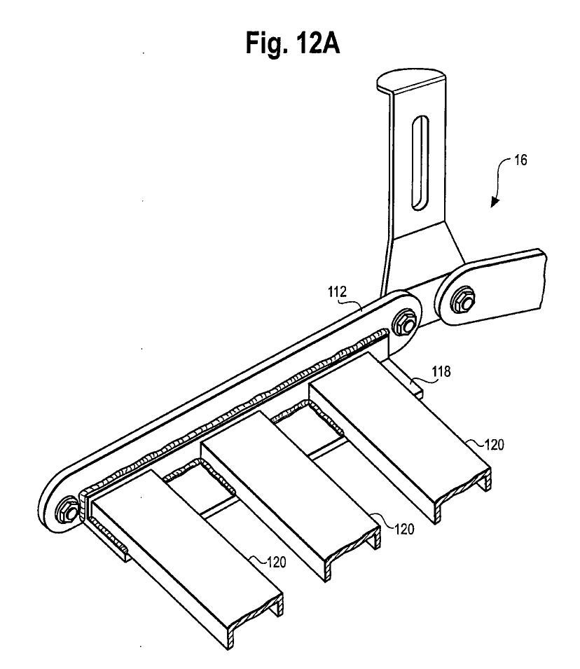

Alternating bolts 82 each have a sliding mounting bracket assembly 88 movably attached thereto for providing an operative connection between the scissors assemblies 12, 14 and the tread support assembly 16. As best seen in FIG. 12, each bracket assembly 88 comprises a plate member 90 having a generally planer upper portion 92, and a lower portion 94 extending in a parallel but different plane than upper portion 92. Upper portion 92 includes an upper flange 96 extending at ninety degrees outward from the top of upper portion 92.

The upper portion 92 of each plate member 90 includes a substantially linear slot 98 through which a portion of bolt 82 extends, allowing relative movement of sliding mounting bracket assembly 88 around and along the axis of bolt 82. Bolt 82 is operatively connected to bracket assembly 88 using suitable washers 100 to mitigate friction and a sufficiently strong threaded nut 102 as is known in the art (FIGS. 8 and 12).

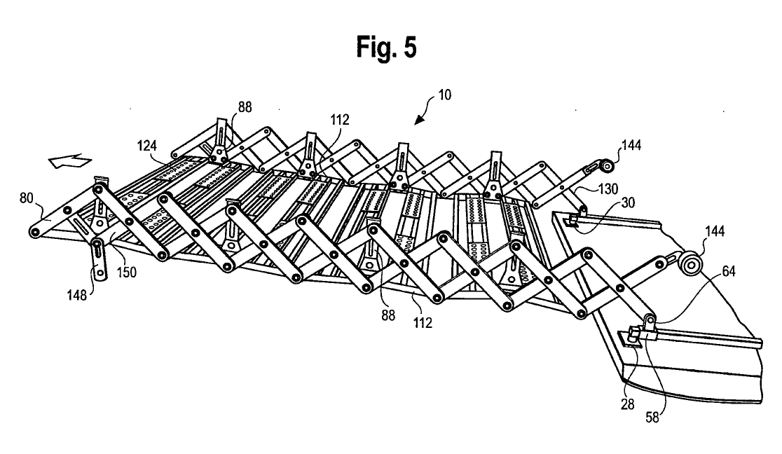

As seen in FIGS. 5 and 12, the lower portion 94 of plate member 90 extends in a second plane relative to the plane of upper portion 92, and the upper portion 92 is connected to the lower portion 94 by an angle piece 104. An aperture 106 extends through plate member 90 to reduce the weight of the plate member.

The lower portion 94 of plate member 90 comprises a pair of apertures 108, through which each a bolt 110 extends, pivotally attaching the lower portion of each plate member 90 to one end of a pair of linkage members 112 that form part of tread support assembly 16, as will be described. Linkage members 112 extend in opposite directions from their respective plate member 90, and are pivotally connected to plate member 90 by means of bolts 114, as is known in the art.

As seen in FIG. 12, the opposite end of each linkage member 112 is pivotally connected by bolt 83 to the lower end 116 of alternate double linkage assemblies 78 and single linkage members 80. As will be explained in more detail, as sliding mounting bracket assembly 88 moves relative to bolt 82, linkage assemblies 112 will pivot about the corresponding bolt 83 between a somewhat horizontal to a somewhat vertical position.

With reference to FIGS. 12 and 12A, each linkage member 112, as mentioned, is part of tread support assembly 16. The tread support assembly, as well as the scissors assemblies 12, 14 are specifically constructed and reinforced to support moving objects in the range of 1,000 to 1,200 pounds, or even higher. To this end, each linkage assembly 112 includes a flange 118 (FIG. 12A) extending ninety degrees from the vertical plane of linkage assembly 112. As seen in FIG. 12A, a plurality of tubular support members 120 are securely fastened by suitable means known in the art, such as welding, bolts or the like, to opposing flanges 118 of opposing linkage assemblies 112. In the illustrated embodiment, three tubular support members 120 are shown supported by flanges 118, however less or more tubular support members may be utilized in accordance with a predetermined balance between load requirements and total weight requirements for the ramp 10. Also, in the illustrated embodiment, tubular support members 120 are shown as having a C-shaped tubular cross-sectional configuration, however it is understood that other cross-sectional configurations such as square, round, and triangular may be utilized to maximize the load capacity of ramp 10.

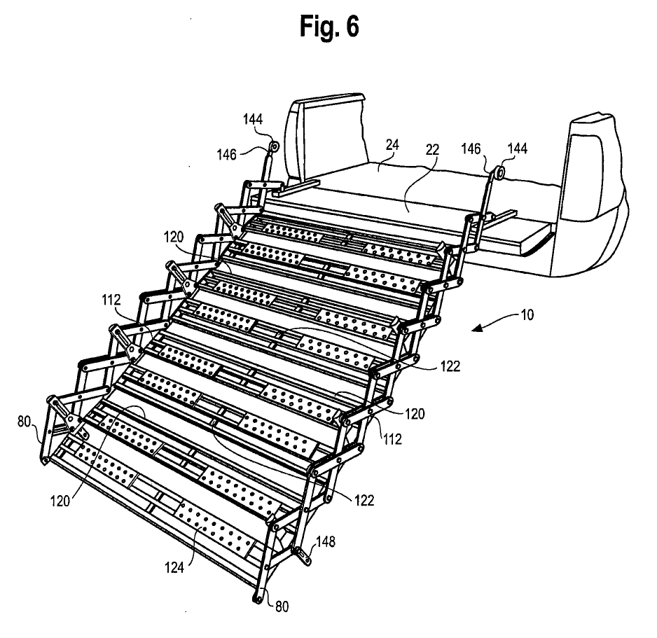

A pair of center bracing struts 122 (FIG. 6) extend between adjacent tubular support members 120 to restrain movement under load of one tubular support member relative to an adjacent member. In the illustrated embodiment, tread plates 124 extend between and are securely fastened to two of the tubular support members. The tread plates 124 are also laterally spaced from each other at positions that substantially correspond to the wheel or tread spacing of vehicles or objects to be movably supported by ramp assembly 10. If desired, additional tread plates 124 may be securely fastened to tubular support members 120. In the illustrated embodiment, one of the tubular support members 120 is not connected to a tread plate 124 to allow manual gripping of the ramp assembly 10, and also to reduce the overall weight of the ramp assembly.

As previously described and referring to FIG. 8, ramp assembly 10 of the present invention is specifically constructed to support heavier moving loads than devices shown in the prior art, while at the same time allowing the ramp to be manually manipulated and moved from place to place for installation, removal and storage. To this end, tread plates 124 are made of relatively thin sheet material, but provide sufficient strength in tension to prevent adjacent tubular support members to which the tread plates 124 are connected from moving away from each other, or buckling, under load. In addition, each tread plate 124 comprises a plurality of countersunk apertures 126 having raised edges 128 that provide additional tensile strength to the tread, as well as a gripping surface on the tread plates 124. The apertures 126 also aid in reducing the total weight of ramp assembly 10.

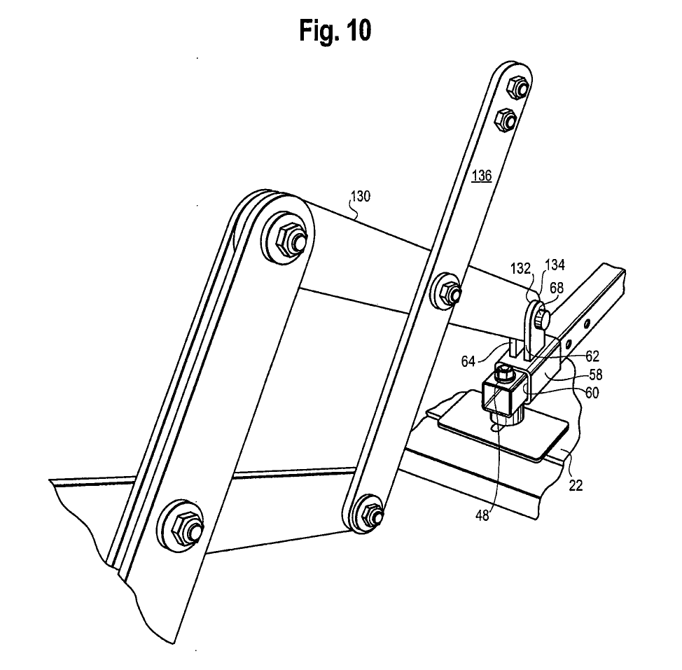

At the end of ramp assembly 10 that is adapted to be slidably attached to mounting rail assemblies 28, 30, and referring to FIGS. 5, 9, 10 and 13, the end single linkage member 130 on both scissors assemblies 12, 14 has an aperture 132 at its outer end 134 (FIG. 10). When ramp assembly 10 is slidably attached to mounting rail assemblies 28, 30, and sliding mounting bracket assembly 88, the outer end 134 of each end single linkage member 130 is placed between respective flanges 62, 64 such that aperture 132 aligns with aperture 66 in each adjacent flange 62, 64. Mounting pin 68 is inserted through the aligned apertures 66, 130 and locking pin 76 is manually inserted into aperture 74. To remove the ramp assembly 10 from sliding mounting bracket assembly 88, locking pin 76 is manually removed from aperture 74, mounting pin 68 is withdrawn from apertures 66, 130, and the entire retracted ramp assembly 10 is manually removed from tailgate 22.

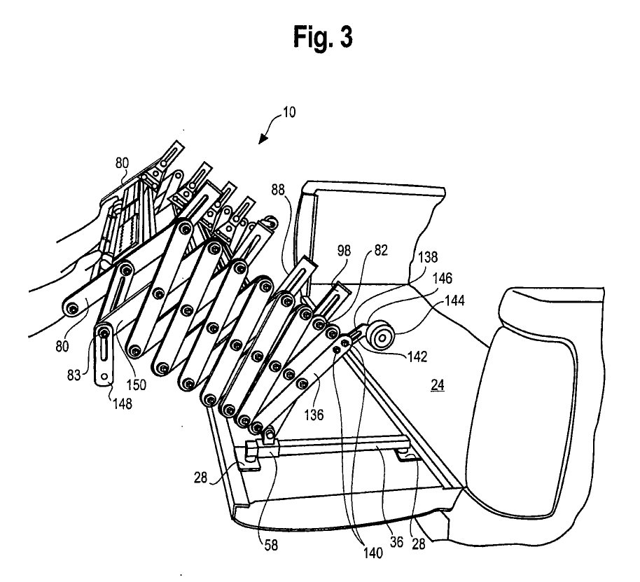

As seen in FIG. 3, another single end link 136 of each scissors assembly 12, 14 includes a roller support bracket 138 mounted for linear movement by bolts 140 to the outer end of single end link 136. Bracket 138 includes a linear slot 142 through which bolts 140 extend, allowing the position of roller support bracket 138 to be linearly and partially rotatively adjusted relative to single end link 136. A roller 144 is rotatively mounted to a portion 146 of roller support bracket 138 that angles downward. As will be explained, roller 146 is adapted to contact the surface of truck bed 24 when ramp assembly 10, in its retracted position, is moved along mounting rail assemblies 28, 30 to prevent damage to truck bed 24.

As seen in FIGS. 2, 4 and 6, a leg 148 extends outward from a bolt 83 on the penultimate outwardly facing linkage 150. As seen in FIG. 6, leg 148 assists in supporting the outer end of ramp assembly 10 on the ground or surface when the ramp assembly is extended.

As is readily apparent, the disclosed ramp assembly 10 is adapted to be extended and retracted each time the ramp assembly is used, utilizing scissors assemblies 12, 14. With reference to FIGS. 5 and 6, when a load is moving on tread plates 124, a downward force is applied to linkage assemblies 112 and to sliding mounting bracket assembly 88. Under certain load conditions, linkage assemblies 112 may be in a flat position, where all of the linkage assemblies 112 are in a straight line, or in an undesirable position where bolts 110 (FIG. 12) may be below the position of bolts 83, causing an “over-center” situation. If a flat or over-center position occurs, as just described, it may be difficult or impossible to retract ramp assembly 10 once it has been expanded and used to support a heavy load.

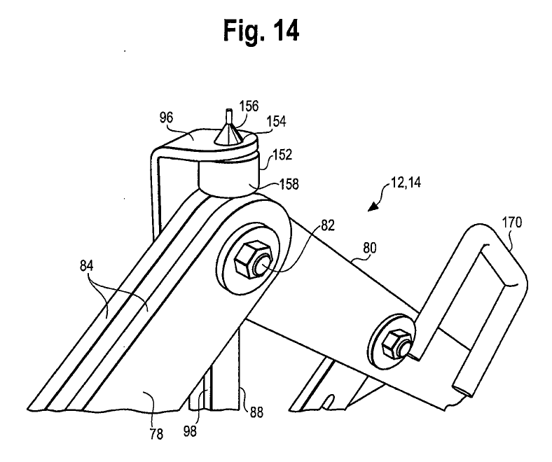

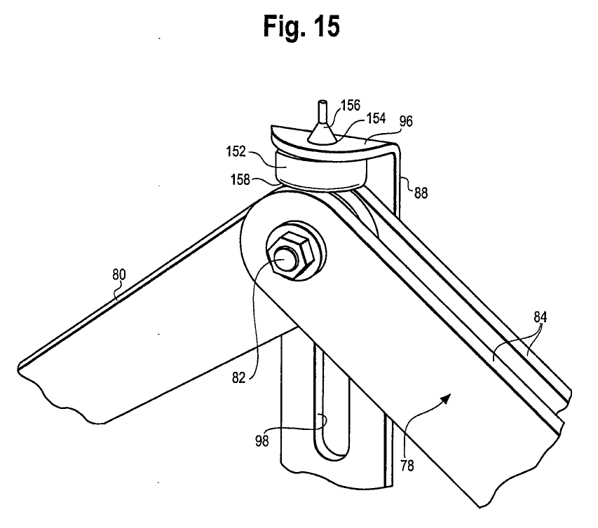

To remedy these potential undesirable situations, one embodiment of the present invention provides a compression cushion or bumper assembly (FIGS. 14, 15) to return the scissors assemblies 12, 14 to a normal, foldable position if the scissors assemblies are disposed in a flat or over-center position. To this end, an elastic or otherwise resilient mass 152 is mounted on the downward side of upper flange 96. The resilient mass 152 could be rubber or a synthetic resilient and elastic material that returns to its original natural shape after compression. In the illustrated embodiment, the upper flange 96 includes an aperture 154 through which a portion 156 of mass 152 extends to hold mass 152 in place beneath upper flange 96. The underside 158 of mass 152 is adapted to engage the upper connection between corresponding double linkage assemblies 78 and single linkage members 80, as seen in FIGS. 14 and 15.

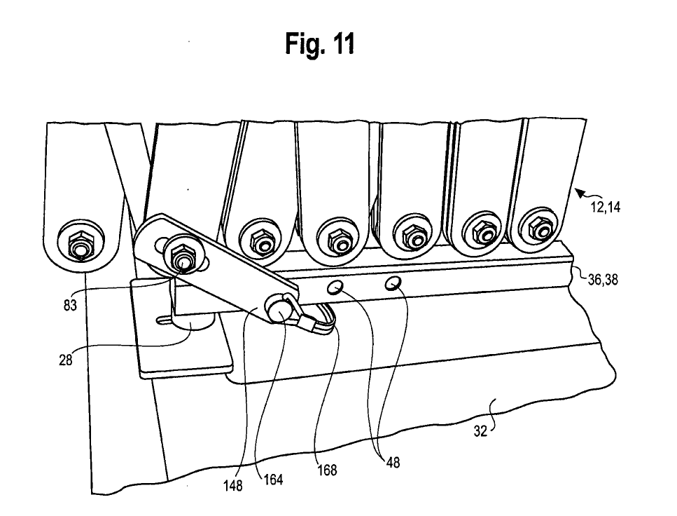

Referring to FIG. 11, leg 148 has an aperture 162 adapted to removably receive a pin 164. The head of pin 164 has a hook-shaped element 168 that is adapted to be inserted into one of the horizontally disposed apertures 48 in mounting rail assemblies 28 and/or 30. When so inserted into an aperture 48, hooked element 168 locks ramp assembly 10 in its retracted position as the vehicle in which ramp assembly 10 is installed traverses rough terrain.

The operation of the ramp assembly will be understood from the following description taken in conjunction with the accompanying drawings. Referring to FIGS. 1 and 9, the ramp assembly 10 is attached to the open tailgate 22 by manually lifting the ramp assembly in its retracted mode to a position adjacent the tailgate, and inserting each end single linkage member 130 between corresponding flanges 62, 64 of tubular slides 58. Each tubular slide 58 is previously moved to its outermost position along rails 36, 38 towards the outer end of tailgate 22. Mounting pins 68 are inserted through apertures 66, and locking pins 76 are inserted through apertures 74, thus pivotally attaching ramp assembly 10 to sliding mounting bracket assemblies 88. The ramp assembly 10 is then manually moved along rails 36, 38 to the position shown in FIG. 2 toward the lower or base portion of tailgate 22. Rollers 144 (FIGS. 1, 3) contact the surface of truck bed 24 to prevent damage to the truck bed as ramp assembly 10 is moved into the position shown in FIG. 2. Tailgate 22 is then pivoted upward about its pivot joints 26 to the position shown in FIG. 1. As the tailgate 22 is lifted, flanges 62, 64 of sliding bracket assembly 58 rotate about mounting pin 68, allowing the tailgate 22 to close and lock, with ramp assembly 10 in the storage position shown in FIG. 1. Referring to FIG. 11, hook shaped element 168 is inserted in one of apertures 48 of a corresponding tubular rail 36, 38, thus locking the ramp assembly 10 in its retracted position.

When it is desired to utilize the ramp assembly 10 to load an object onto the truck bed 24, the tailgate 22 is lowered to the position shown in FIG. 2, and the ramp assembly 10 is moved outward along rails 36, 38 until the tubular slides 58 are in the position shown in FIG. 3. To move ramp assembly 10 to its expanded position, the outermost tubular support member 120 is grabbed by both hands of the user at locations that in the illustrated embodiment are marked with the instruction “Grab Here.” Alternatively, handles 170 (FIG. 14) are placed on the outward-most links 80 of scissors assemblies 12, 14. The user walks backward, as shown in FIG. 3, continually expanding the ramp assembly 10 through the positions shown in FIGS. 3 to 5. When fully expanded, the user places the outermost tubular support member 120 on the ground or other surface as shown in FIG. 6. The outermost portions of ramp assembly 10 will contact the ground or surface, as does the bottom portion of leg 148.

During the process of expanding ramp assembly 10, the sliding mounting bracket assemblies 88 move from the position shown in FIG. 3 to the position shown in FIG. 5, with bolts 82 moving in slot 98. As sliding bracket assemblies 88 move downward, linkage assemblies 112 of tread support assembly 16 move from a somewhat parallel position relative to each other (FIGS. 2, 3) to a somewhat aligned position relative to each other (FIGS. 5, 6). In the expanded position, tubular support members 120 and tread plates 124 form a support surface along which objects can move as the objects are loaded onto or removed from truck bed 24. The structure of support members 120 absorbs and distributes heavy loads to linkage assembly 112 and to the reinforced structure of scissors assemblies 12, 14. In addition, and working in combination with support members 120, tread plates 124 distribute the load among the support members 120 to which the tread plates are attached. The raised edges 128 surrounding apertures 126 in tread plate 124 combine with the support members to provide the strength necessary for ramp assembly 10 to support heavy moving loads.

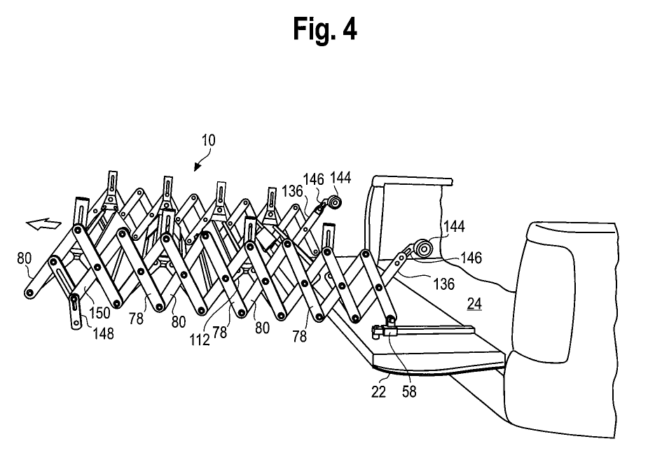

Referring to FIG. 14, as sliding mounting bracket assembly 88 moves downward along bolt 82 during the expansion process, the underside 158 of resilient mass 152 eventually contacts the upper edges of links 80 and 84, causing the resilient mass to compress. Thus, even if the scissors assemblies 12, 14 move to a “flat” or “over-center” position, the stored energy in compressed resilient mass 152 will force the scissors assemblies 12, 14 in a direction back to the position shown in FIGS. 4 and 5, allowing the ramp assembly 10 to be readily moved to its retracted position.

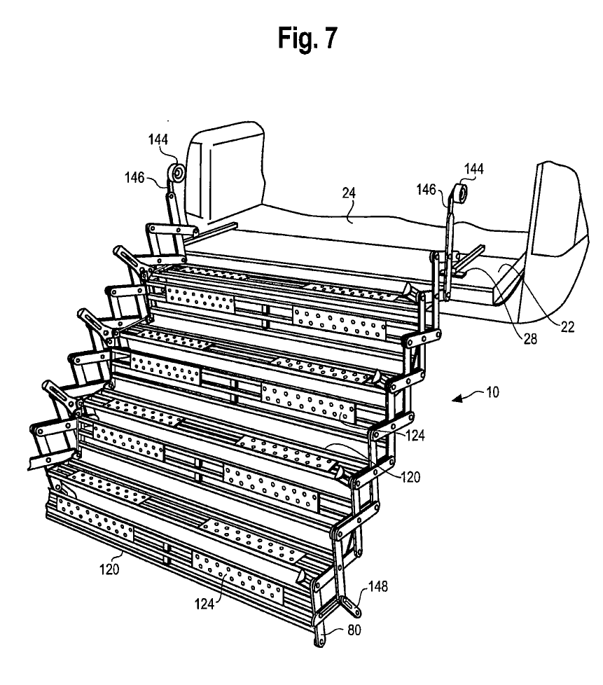

As seen in FIG. 7, partially expanding ramp assembly 10 to less than its fully expanded position results in the ramp assembly forming a stairway leading from the ground or other surface to the truck bed 24. In this position, the outermost linkage member 80 and leg 148 rest on the ground or surface to assist in supporting the ramp assembly 10 in the staircase configuration. The inherent friction between all of the pivotal linkages of the described ramp assembly 10 also combines to maintain the ramp assembly in the staircase position.

When it is desired to retract the ramp assembly 10, the outermost tubular support member 120, or handles 170 (FIG. 14), are grasped by the user with both hands and lifted to the position shown in FIG. 5. The user then walks toward the tailgate 22, moving the scissors assemblies 12, 14 into the position shown in FIG. 4, and ultimately to the position shown in FIG. 3. The scissors assemblies 12, 14 and their constituent parts will operate in the opposite manner as described above for the expansion process.

When the retraction of ramp assembly 10 is completed, further lateral pressure on the retracted ramp assembly 10 will cause tubular slides 58 to move along rail members 36, 38 until ramp assembly 10 is in the position shown in FIG. 2, with rollers 144 (FIG. 3) contacting truck bed 24 to prevent damage to the truck bed. The tailgate 22 is then lifted, and ramp assembly 10 pivots about mounting pin 68 until the ramp assembly and the tailgate are in the position shown in FIG. 1. Pin 164 is inserted in aperture 160 of leg 148. Hook shaped element 168 (FIG. 11) is then inserted into one of the apertures 48 of rail members 36, 38, thus locking the retracted ramp assembly 10 against movement.

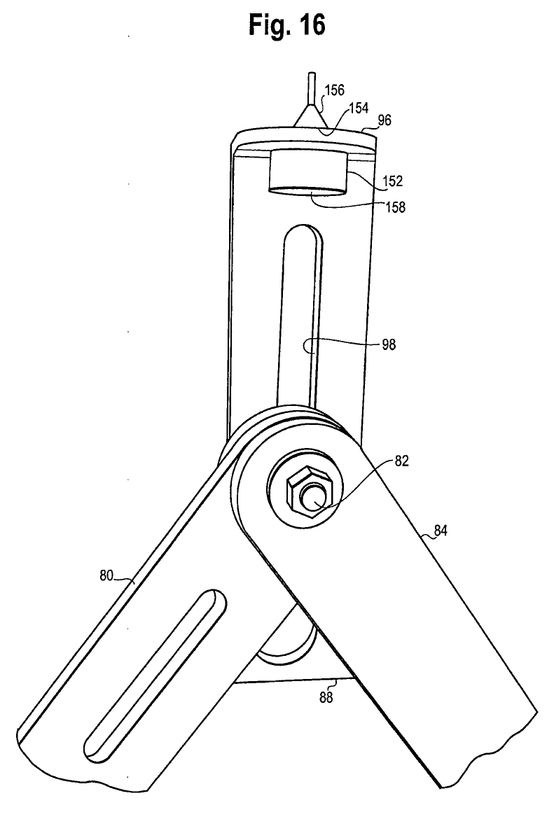

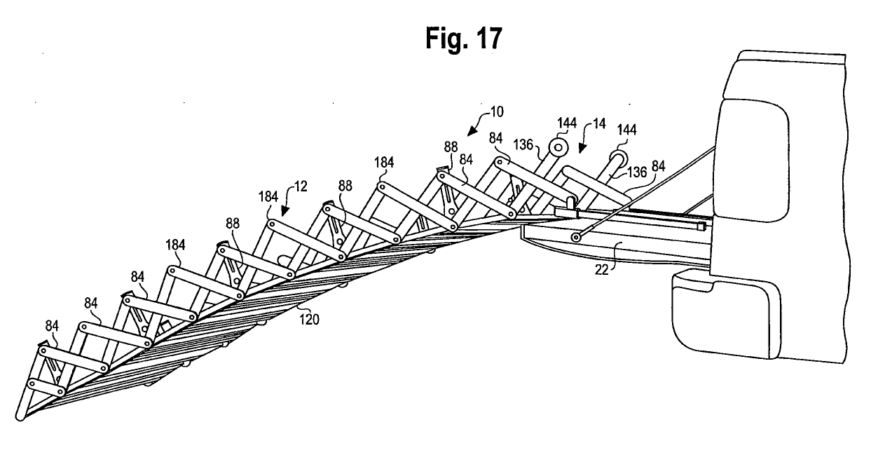

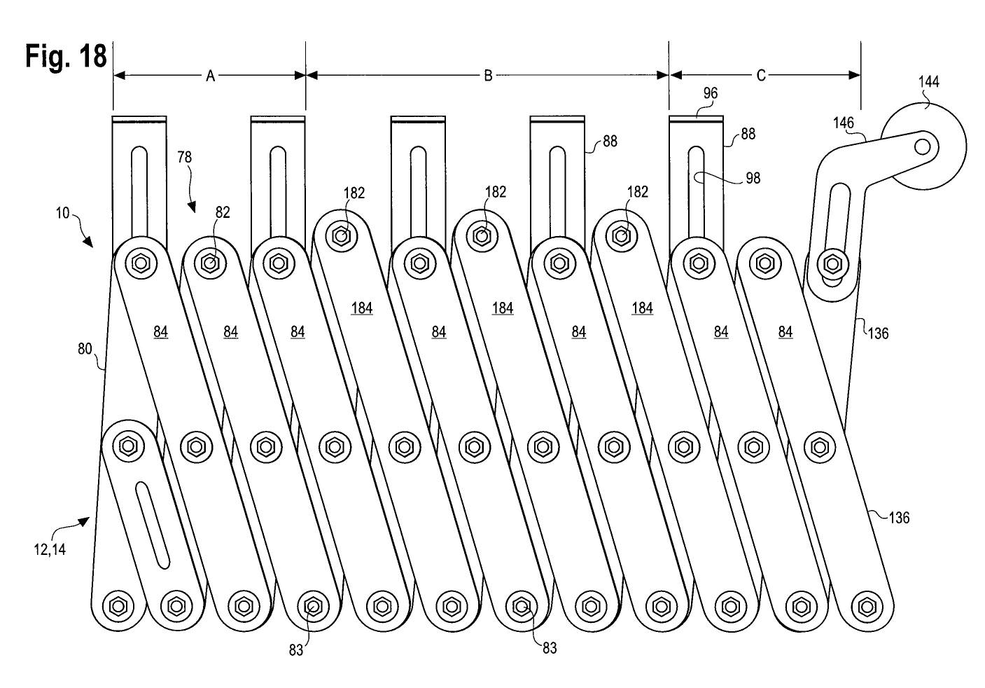

A second embodiment of the present invention is illustrated on FIGS. 17 and 18, where like parts shown in FIGS. 1-16 have the same identifying designations. In this embodiment, certain of the linkages members of double linkage assemblies 78 are lengthened at their upper ends, as seen in FIG. 18. This alternate construction of the ramp 10 provides a central curved or arced configuration of ramp 10, as seen in FIG. 17, which configuration prevents vehicles with low frame structures from bottoming out or hitting the junction between the ramp 10 and the rear edge of tailgate 22 when advancing such low frame vehicles up or down the ramp 10.

To accomplish this purpose, referring to FIG. 18, for purposes of explanation, the ramp 10 is folded to its retracted position, comparable to that shown in FIG. 2. In FIG. 18, portion or segment A designates the link members 80, 84 that comprise the single and double linkage members of scissor assemblies 12, 14 forming the front end of the ramp 10, that is the portion of the ramp 10 constructed to extend furthest away from tailgate 22 (FIG. 17). Portion or segment C (FIG. 18) designates the link members 80, 84 that comprise the single and double linkage members of scissors assemblies 12, 14 forming the rear end of the ramp 10, that is the portion of ramp 10 closest to tailgate 22.

Between end portions A and C are middle portions or segments B of scissors assemblies 12, 14. Middle portion B, in the illustrated embodiment, includes three link members 184 that are longer in length than other link members 84. Links 184 are part of double link assemblies 78, and the rear link 184 is not shown in FIG. 17 or 18.

In the illustrated embodiment of FIGS. 17 and 18, the three longer link members 184 are alternately spaced, with link members 84 of normal length disposed between elongated links 184. From FIG. 18, it is seen that none of the elongated links 184 are slidably attached to a sliding bracket assembly 88, as are link members 84 interspersed between link members 184. Thus, the extension and retraction of the ramp 10 shown in FIGS. 17, 18 operate in the same manner as described for the ramp 10 shown in FIGS. 1-16.

In the illustrated embodiment of FIGS. 17, 18, each link member 184 extends upward beyond the length of link members 84 in the range of three-eighths to three quarter inches. Empirically, it has been found that extending each link 184 by an amount of one-half inch beyond the length of link members 84 provides an optimum arc configuration for the ramp 10.

In the embodiment of FIGS. 17, 18, the links 84 in portions A and C of ramp 10 are not extended. This provides that the entrance to ramp 10 at the outer end of portion A is not too steep to prevent a wheeled or treaded vehicle from entering or leaving the ramp. Likewise, by not including elongated links 184 in portion C of ramp 10, the position of portion C adjacent tailgate 22 is gradual enough to allow a wheeled or treaded vehicle to make a smooth, somewhat horizontal transition from the ramp 10 to the tailgate 22 and on to truck bed 24.

Due to the elongated length of link members 184 in the central portion or segment B of ramp 10 shown in FIGS. 17, 18, when expanded, as seen in FIG. 17, the portion B of the ramp is arcuate in configuration, while portions or segments A and C remain in somewhat a flat configuration. Thus, when a wheeled or treaded vehicle advances up ramp 10, as the vehicle approaches the junction between ramp 10 and tailgate 22, the rear wheels or rear tread assemblies of the vehicle are raised. If the vehicle has a low frame, the raising of the rear wheels or tread assemblies prevents the low frame from contacting the tailgate 22 at the junction between the ramp 10 and tailgate 22. When removing a vehicle from bed 24 and tailgate 22 of the truck or other cargo carrying device, the leading wheels or leading tread assemblies are likewise raised to prevent a low frame from hitting the tailgate-ramp junction.

The foregoing description of a preferred embodiment of the invention has been presented for purposes of illustration and description, and is not intended to be exhaustive or to limit the invention to the precise form disclosed. The description was selected to best explain the principles of the invention and practical application of these principals to enable others skilled in the art to best utilize the invention in various embodiments and various modifications as are suited to the particular use contemplated. It is intended that the scope of the invention not be limited by the specification, but be defined by the claims set forth below.

I claim:

1. An expandable and retractable ramp assembly for conveying moving objects onto a cargo carrying surface of a cargo transporting apparatus, said ramp assembly comprising:
a. a pair of opposed, parallel scissors assemblies, each said scissors assembly including a plurality of scissors link members pivotally attached to other scissors link members of the same scissors assembly;
b. a plurality of tread support assemblies, each tread support assembly extending between and pivotally attached to one of said scissors link members of each opposed scissors assembly;
c. each tread support assembly comprising a plurality of support members pivotally attached to said scissors link members of each opposed scissors assembly;
d. said tread support assemblies each supporting at least one tread plate.

2. The ramp assembly of claim 1, wherein each said plurality of scissors link members comprises first scissors links and second scissors links pivotally connected to form an expandable and retractable support system, each said first scissors link pivotally connected to a second scissors link at the ends and center of each said first scissors link;
said tread support assemblies each comprising opposed linkage members pivotally connected at a first end of each linkage member to a lower intersecting end of certain of said first and second scissors links, a second end of each said linkage member pivotally connected to a sliding mounting bracket, the sliding mounting bracket slidably connected to an upper intersection of a first and second scissors link.

3. The ramp assembly of claim 2, wherein each tread support assembly is securely fastened to two opposed linkage members.

4. The ramp assembly of claim 1, wherein: said tread plates extend between at least two of said support members.

5. The ramp assembly of claim 1 wherein: each of said tread plates includes a plurality of apertures extending through each treadplate, raised edges circumferentially disposed about each aperture, said raised edges and said apertures combining to provide strength and a gripping surface to the tread plates.

6. The ramp assembly of claim 1 wherein: said support members and said attached tread plates, in combination, are adapted to support and distribute the weight of loads on the ramp assembly.

7. The ramp assembly of claim 1, comprising rail-like mounting elements adapted to be securely attached to a portion of the cargo transporting apparatus; and said ramp assembly removably, slidably, and pivotally mounted to said rail-like mounting elements for linear and rotative movement relative to said rail-like mounting elements.

8. The ramp assembly of claim 1, wherein: each support member is tubular in shape.

9. An expandable and retractable ramp assembly for conveying moving objects onto a cargo carrying surface of a cargo transporting apparatus, said ramp assembly comprising:
a. a pair of opposed parallel scissors assemblies, each scissor assembly including a plurality of first scissor links pivotally connected to an adjacent second scissors link to form said scissors assembly, each said first scissors link connected to an adjacent second scissors link at an upper end, lower end and central portion of each first scissors link;
b. each said second scissors link pivotally connected at a junction formed at one end of each second scissors link to an end of a pair of first scissors links;
c. an opposite end of two adjacent second scissors links slidably connected to a sliding mounting bracket, the sliding mounting bracket slidably connected to the upper end of a pair of pivotally connected first and second scissors links;
d. a plurality of tread support assemblies, each tread support assembly pivotally attached to a junction between a first scissors link and a second scissors link, and to a sliding mounting bracket;
e. each said sliding mounting bracket having an upper flange extending outward from said sliding mounting bracket, said flange extending over the upper end of the junction between a first scissors link and a second scissors link;
f. a resilient mass disposed between said flange and said upper junction, said resilient mass being compressed when the flange moves to a position adjacent a corresponding upper junction.

10. The ramp assembly of claim 9 wherein:
said resilient mass prevents said first and second scissors links from reaching an over-center position upon expansion of said scissor assemblies and movement of each slidable mounting bracket to its expanded position.

11. An expandable and retractable ramp assembly for conveying moving objects onto a cargo carrying surface of a cargo transporting apparatus, a mid-portion of said ramp assembly having an arcuate configuration, said ramp assembly comprising:
a. a pair of spaced apart parallel disposed scissors assemblies;
b. a tread support assembly extending between and supported by said parallel disposed scissors assembly;
c. each scissor assembly comprising a plurality of first and second scissors links, each first scissors link pivotally attached to an adjacent second scissors link of said scissors assembly to form said scissors assembly;
d. a first portion of said plurality of first scissor links in each scissors assembly having a first length;
e. a second portion of said plurality of first scissors links in each scissors assembly located in the mid-portion of said ramp assembly;
f. a plurality of said first scissors links in said second portion having a second length, said second length being greater than said first length;
g. said mid-portion of said ramp assembly having an arcuate configuration when said ramp assembly is in an expanded position.

12. The ramp assembly of claim 11, wherein:
a. said first scissors links extend in a first direction;
b. said second scissors links extend in a second direction;
c. a first segment of said first and second scissors links disposed at one end of said ramp assembly;
d. a second segment of said first and second scissors links disposed at an opposite end of said ramp assembly;
e. a third segment of said first and second scissors links disposed at said mid-portion of said ramp assembly;
f. said first and second segments each comprising said first portion of said plurality of first scissors links having said first length;
g. said third segment at said mid-portion of said ramp, said third segment comprising said first scissors links having said first length and first scissors links having said second length.

13. The ramp assembly of claim 12, wherein said third segment comprises first scissors links of said first length disposed between first scissors links of said second length.

14. The ramp assembly of claim 11, wherein said second length is greater than said first length by a dimension in the range of ⅜ inches to ¾ inches.

15. The ramp assembly of claim 11, wherein said second length is greater than said first length by a dimension of ½ inch.
